(19) United States
(12) Patent Application Publication
(10) Pub. No.: US 2017/0023872 A1
(43) Pub. Date: Jan. 26, 2017

(54) ELECTROSTATIC LATENT IMAGE-DEVELOPING TONER AND METHOD OF PRODUCING ELECTROSTATIC LATENT IMAGE-DEVELOPING TONER

(71) Applicant: Konica Minolta, Inc., Tokyo (JP)

(72) Inventors: Junya UEDA, Tokyo (JP); Shiro HIRANO, Tokyo (JP); Kenshi MIYAJIMA, Tokyo (JP)

(21) Appl. No.: 15/069,068

(22) Filed: Mar. 14, 2016

(30) Foreign Application Priority Data
Apr. 2, 2015 (JP) 2015-075871

(51) Int. Cl. G03G 9/087; G03G 9/08

(52) U.S. Cl. CPC G03G 9/08711; G03G 9/0804; G03G 9/0815; G03G 9/0821; G03G 9/08755; G03G 9/0819

(57) ABSTRACT

An electrostatic latent image-developing toner includes a styrene-acrylic resin, an amorphous polyester resin, and a crystalline polyester resin. The electrostatic latent image-developing toner shows maximum absorption peaks at least in absorption wavenumber ranges of 690 to 710 cm⁻¹, 1190 to 1220 cm⁻¹, and 1230 to 1300 cm⁻¹ in an absorption spectrum measured by attenuated total reflection with a Fourier transform infrared spectrometer. The ratio (P3/P1) of the height (P3) of the maximum absorption peak in the range of 1230 to 1300 cm⁻¹ to the height (P1) of the maximum absorption peak in the range of 690 to 710 cm⁻¹ is 0.02 to 6.00.

### 1. FIELD OF THE INVENTION

The present invention relates to an electrostatic latent image-developing toner and a method of producing the electrostatic latent image-developing toner, in particular, relates to an electrostatic latent image-developing toner that has both low-temperature fixability and heat resistance and a method of producing the electrostatic latent image-developing toner.

### 2. DESCRIPTION OF RELATED ART

High-speed operation and the high-quality image formation in electrophotographic image forming apparatuses have been increasingly demanded in recent years. Electrostatic latent image-developing toners for the apparatuses also have been developed at a high pace for responding to the demands from the market. For example, a toner must have a narrow particle diameter distribution suitable for high image quality.

A toner having a uniform particle diameter with a narrow particle diameter distribution makes the development behavior of individual toner base particles uniform, leading to a considerable improvement in reproducibility of a minute dot. Traditional methods of producing toner by a pulverization process, however, cannot readily produce toner having a narrow particle diameter distribution.

Emulsion aggregation has been proposed as a method of producing toner base particles with appropriately controlled shape and particle diameter distribution. This method prepares toner base particles by mixing an emulsion dispersion of resin particles with a coloring agent particle dispersion and an optional release agent dispersion, adding a flocculant to the mixture with stirring, aggregating the particles by, for example, pH control, and then fusing the particles through heating.

In addition, from the viewpoint of saving energy, low-temperature fixing toners, which can be fixed by low energy, have been developed. A decrease in fixing temperature of a toner requires a reduction in melting temperature or melting viscosity of resin. A decrease in glass transition point or molecular weight of resin for reducing the resin melting temperature or melting viscosity, however, raises new problems, such as a decrease in the heat-resistant storage properties of the toner.

Techniques for achieving compatibility between low-temperature fixability and heat-resistant storage properties have been proposed (for example, see Japanese Unexamined Patent Application Publication Nos. 2014-174315, 2014-174186, 2014-174262, and 2007-206097). These techniques specify the ratio of the peak height of a spectrum assigned to a crystalline polyester resin to the peak height of a spectrum assigned to an amorphous polyester resin.

In these documents, however, the main component of the amorphous resin is an amorphous polyester resin, and the content of a styrene-acrylic resin is less than 10%. In such a structure, the amorphous resin is compatible with the crystalline resin, resulting in a reduction in heat resistance. In addition, the toner produced by a pulverization process precludes control of the state of the amorphous polyester resin present in the vicinity of the toner surface.

### SUMMARY OF THE INVENTION

An object of the present invention, which has been made in view of the above-described problems and circumstances, is to provide an electrostatic latent image-developing toner that has both low-temperature fixability and heat resistance and a method of producing the electrostatic latent image-developing toner.

In the process of investigating the causes of the above-mentioned problems for achieving the above-mentioned object, the present inventors have found that low-temperature fixability and heat resistance can be simultaneously achieved by controlling the state of an amorphous polyester resin and a styrene-acrylic resin present in the vicinity of the surface of toner base in the presence of a crystalline polyester resin and an amorphous polyester resin, and have arrived at the present invention.

The object of the present invention can be achieved by the following aspects:

According to a first aspect of a preferred embodiment of the present invention, there is provided an electrostatic latent image-developing toner including a styrene-acrylic resin; an amorphous polyester resin; and a crystalline polyester resin, wherein the electrostatic latent image-developing toner shows maximum absorption peaks at least in absorption wavenumber ranges of 690 to 710 cm⁻¹, 1190 to 1220 cm⁻¹, and 1230 to 1300 cm⁻¹ in an absorption spectrum measured by attenuated total reflection with a Fourier transform infrared spectrometer, and the ratio (P3/P1) of the height (P3) of the maximum absorption peak in the range of 1230 to 1300 cm⁻¹ to the height (P1) of the maximum absorption peak in the range of 690 to 710 cm⁻¹ is 0.02 to 6.00.

Preferably, the amount of the styrene-acrylic resin is in a range of 50% to 90% by mass based on the total amount of the resins contained in the electrostatic latent image-developing toner.

Preferably, the ratio (P2/P1) of the height (P2) of the maximum absorption peak in the range of 1190 to 1220 cm⁻¹ to the height (P1) of the maximum absorption peak in the range of 690 to 710 cm⁻¹ is 0.20 or less.

Preferably, the ratio (P2/P1) of the height (P2) of the maximum absorption peak in the range of 1190 to 1220 cm⁻¹ to the height (P1) of the maximum absorption peak in the range of 690 to 710 cm⁻¹ is in a range of 0.02 to 0.20.

Preferably, the ratio (P2/P1) of the height (P2) of the maximum absorption peak in the range of 1190 to 1220 cm⁻¹ to the height (P1) of the maximum absorption peak in the range of 690 to 710 cm⁻¹ is in a range of 0.02 to 0.10.

Preferably, the ratio (P3/P1) of the height (P3) of the maximum absorption peak in the range of 1230 to 1300 cm⁻¹ to the height (P1) of the maximum absorption peak in the range of 690 to 710 cm⁻¹ is in a range of 0.05 to 1.00.

Preferably, the ratio (P3/P1) of the height (P3) of the maximum absorption peak in the range of 1230 to 1300 cm⁻¹ to the height (P1) of the maximum absorption peak in the range of 690 to 710 cm⁻¹ is in a range of 0.05 to 0.50.

According to a second aspect of a preferred embodiment of the present invention, there is provided a method of producing an electrostatic latent image-developing toner according to the first aspect, the method including: aggregating and fusing at least styrene-acrylic resin particles, amorphous polyester resin particles, and crystalline polyester resin particles; and cooling an aqueous dispersion of the resultant toner base particles at a cooling rate of 10° C. to 30° C./min.

Although the mechanism of expression or function of the effects of the present invention has not been revealed, they are believed as follows.

The amounts of the styrene-acrylic resin and the amorphous polyester resin present in the vicinity of the surface of toner base particle can be optimized by adjusting the ratio (P3/P1) of the peak height (P3) to the peak height (P1) within a range of 0.02 to 6.00. Since an amorphous polyester resin compatibilized with a crystalline polyester resin and a styrene-acrylic resin incompatible with the crystalline polyester resin are present, a decrease in heat resistance due to the compatibilized amorphous polyester resin can be prevented by the styrene-acrylic resin, and the presence of a certain amount of the amorphous polyester resin compatibilized with the crystalline polyester resin in the vicinity of the surface of toner base particle helps expression of fixability during fixing and provides good low-temperature fixability, leading to compatibility between heat resistance and low-temperature fixability.

### BRIEF DESCRIPTION OF THE DRAWINGS

The present invention will become more fully understood from the detailed description given hereinbelow and the appended drawings which are given byway of illustration only, and thus are not intended as a definition of the limits of the present invention, and wherein:

FIG. 1 is a graph showing an example absorption spectrum observed by attenuated total reflection (ATR).

### DETAILED DESCRIPTION OF THE PREFERRED EMBODIMENT

The electrostatic latent image-developing toner of the present invention at least contains a styrene-acrylic resin, an amorphous polyester resin, and a crystalline polyester resin. The electrostatic latent image-developing toner shows maximum absorption peaks at least in absorption wavenumber ranges of 690 to 710 cm⁻¹, 1190 to 1220 cm⁻¹, and 1230 to 1300 cm⁻¹ in an ATR absorption spectrum measured with a Fourier transform infrared spectrometer, wherein the ratio (P3/P1) of the height (P3) of the maximum absorption peak in the range of 1230 to 1300 cm⁻¹ to the height (P1) of the maximum absorption peak in the range of 690 to 710 cm⁻¹ is 0.02 to 6.00. This is a technical feature common to the inventions according to the first and second aspects.

In a preferred embodiment of the present invention, the amount of the styrene-acrylic resin is 50% to 90% by mass based on the total amount of the resins contained in the electrostatic latent image-developing toner, from the viewpoint of enhancing the advantageous effects of the present invention. Such a range of content contributes to significant improvements in dispersibility of a coloring agent and low-temperature fixability.

In addition, the ratio (P2/P1) of the height (P2) of the maximum absorption peak in the range of 1190 to 1220 cm⁻¹ to the height (P1) of the maximum absorption peak in the range of 690 to 710 cm⁻¹ is preferably 0.20 or less. A ratio of 0.20 or less can avoid an excess amount of the crystalline polyester resin present on the surface of toner base particle, can readily decrease the melting point of the toner, and thus can improve the low-temperature fixability. A reduction in the amount of the crystalline polyester resin on the surface of toner base particle can also enhance the fluidity of the toner.

The ratio (P2/P1) is preferably in a range of 0.02 to 0.20 and most preferably in a range of 0.02 to 0.10.

The ratio (P3/P1) of the height (P3) of the maximum absorption peak in the range of 1230 to 1300 cm⁻¹ to the height (P1) of the maximum absorption peak in the range of 690 to 710 cm⁻¹ is more preferably in a range of 0.05 to 1.00. The toner having a ratio (P3/P1) of 1.00 or less includes a styrene-acrylic resin incompatible with the crystalline polyester resin in the vicinity of the surface of toner base particle and thereby has enhanced heat resistance, whereas the toner having a ratio (P3/P1) of 0.05 or more includes a compatibilized amorphous polyester resin in the vicinity of the surface of toner base particle and is thereby soluble during fixing, leading to an improvement in low-temperature fixability. The ratio (P3/P1) is more preferably in a range of 0.05 to 0.50.

In addition, an aqueous dispersion of toner base particles prepared by aggregation and fusion of at least styrene-acrylic resin particles, amorphous polyester resin particles, and crystalline polyester resin particles is cooled at a cooling rate ranging from 10° C./min to 30° C./min, which prevents recrystallization of the crystalline polyester resin to decrease the peak intensity ratio (P2/P1).

The present invention, constituents, and embodiments implementing the present invention will now be described in detail. It should be noted that, throughout the specification, the term to indicating the numerical range is meant to be inclusive of the lower and upper limits represented by the numerals given before and after the term.

### [Electrostatic Latent Image-Developing Toner]

The electrostatic latent image-developing toner of the present invention includes toner base particles at least containing a styrene-acrylic resin, an amorphous polyester resin, and a crystalline polyester resin.

The electrostatic latent image-developing toner has maximum absorption peaks of maximum absorbance (hereinafter, simple referred to as “maximum absorption peaks”) at least in absorption wavenumber ranges of 690 to 710 cm⁻¹, 1190 to 1220 cm⁻¹, and 1230 to 1300 cm⁻¹, wherein the ratio (P3/P1) of the height (P3) of the maximum absorption peak in the range of 1230 to 1300 cm⁻¹ to the height (P1) of the maximum absorption peak in the range of 690 to 710 cm⁻¹ is in a range of 0.02 to 6.00.

The ratio (P3/P1) of the height (P3) of the maximum absorption peak in the range of 1230 to 1300 cm⁻¹ to the height (P1) of the maximum absorption peak in the range of 690 to 710 cm⁻¹ is preferably in a range of 0.05 to 1.00 and more preferably in a range of 0.05 to 0.50.

The ratio (P3/P1) is restricted in a range of 0.02 to 6.00. At a ratio adjusted to 6.00 or less, the styrene-acrylic resin incompatible with the crystalline polyester resin present in the vicinity of the surface of toner base particle prevents the influence of the amorphous polyester resin compatibilized with the crystalline polyester resin during the storage of the toner, leading to an improvement in heat resistance.

At a ratio adjusted to 0.02 or more, a reduced amount of styrene-acrylic resin is present in the vicinity of the surface of toner base particle, and the compatibilized amorphous polyester resin is readily soluble during fixing, maintaining proper low-temperature fixability.

For example, in the case of producing a toner by emulsion aggregation, the ratio (P3/P1) can be adjusted within a range of 0.02 to 6.00 through control of the timing of feed of an amorphous polyester resin particle dispersion in the aggregation and fusion step in the production of the toner. Specifically, a crystalline polyester resin particle dispersion and a styrene-acrylic resin particle dispersion are preferably added as a first-stage dispersion, and an amorphous polyester resin particle dispersion is preferably added as a second-stage dispersion. Such a method can control the state of the amorphous polyester resin and the styrene-acrylic resin present in the vicinity of the surface of toner base particle.

The ratio (P2/P1) of the height (P2) of the maximum absorption peak in the range of 1190 to 1220 cm⁻¹ to the height (P1) of the maximum absorption peak in the range of 690 to 710 cm⁻¹ is preferably 0.20 or less, more preferably in a range of 0.02 to 0.20, and most preferably in a range of 0.02 to 0.10.

A ratio (P2/P1) adjusted to 0.20 or less prevents an excessive amount of crystalline polyester resin from being present on the surface of toner base particle. A reduced amount of crystalline polyester resin present on the surface of toner base particle readily decreases the melting point of the toner and thus further improves the low-temperature fixability.

A large amount of crystalline polyester resin present on the surface of toner base particle readily causes phenomena of shape distortion and softening of the surface of toner base particle and has a tendency to reduce the toner fluidity. Such phenomena can be avoided by decreasing the amount of the crystalline polyester resin present on the surface of toner base particle, as described above, and the fluidity of the toner can be increased.

The ratio (P2/P1) can be adjusted to 0.20 or less by, for example, aggregating and fusing the styrene-acrylic resin particles, the amorphous polyester resin particles, and the crystalline polyester resin particles in the production of the toner and then cooling an aqueous dispersion of the resulting toner base particles (cooling step) in a cooling rate in the range of 10° C./min to 30° C./min. A cooling rate adjusted in the range of 10° C./min to 30° C./min precludes recrystallization of the crystalline polyester resin, leading to a reduction of the peak intensity ratio (P2/P1) to 0.20 or less.

### <Determination of Peak Height Ratio>

The ratio (P3/P1) of the height (P3) of the maximum absorption peak in the range of 1230 to 1300 cm⁻¹ to the height (P1) of the maximum absorption peak in the range of 690 to 710 cm⁻¹ can be determined from the ratio of peak intensities in an absorption spectrum measured with a Fourier transform infrared spectrometer (Nicolet 380, manufactured by Thermo Fisher Scientific K.K.) by attenuated total reflection (ATR).

A load of 400 kgf is applied to a toner (0.2 g) for 1 min with a pelleting machine (SSP-10A, manufactured by Shimadzu Corporation) to produce a sample pellet with a diameter of 10 mm.

The ATR measurement is performed with a diamond crystal under conditions of a resolution of 4 cm⁻¹ and an accumulated number of 32. The resulting ATR spectrum is corrected in accordance with the correction procedure of the machine, and the value of the peak intensity ratio is determined from the ATR corrected spectrum.

The maximum absorption peak with a height (P1) in the range of 690 to 710 cm⁻¹ is assigned to styrene-acryl and is defined as follows.

In an absorption wavenumber range of 690 to 710 cm⁻¹, a maximum peak point Mp1 with a maximum absorbance is observed between the bottom point at which the absorbance is the lowest (hereinafter referred to as “first bottom point Fp1”) and the bottom point at which the absorbance is the second lowest (hereinafter referred to as “second bottom point Fp2”). A line segment connecting the first bottom point Fp1 and the second bottom point Fp2 is referred to as a base line. The height P1 of the maximum peak point Mp1 is the absolute value of the difference between the absorbance at the maximum peak point Mp1 and the absorbance at the intersection point of the base line and the perpendicular line drawn from the maximum peak point Mp1 toward the horizontal axis.

The maximum absorption peak with a height (P2) in the range of 1190 to 1220 cm⁻¹ is assigned to crystalline polyester and is defined as follows.

In an absorption wavenumber range of 1190 to 1220 cm⁻¹, a maximum peak point of the maximum absorbance is observed between the bottom point at which the absorbance is the lowest e (hereinafter referred to as “first bottom point”) and the bottom point at which the absorbance is the second lowest (hereinafter referred to as “second bottom point”). A line segment connecting the first bottom point and the second bottom point is referred to as abase line. The height P2 of the maximum peak point is the absolute value of the difference between the absorbance at the maximum peak point and the absorbance at the intersection point of the base line and the perpendicular line drawn from the maximum peak point toward the horizontal axis.

The maximum absorption peak with a height (P3) in the range of 1230 to 1300 cm⁻¹ is assigned to amorphous polyester and is defined as follows.

In an absorption wavenumber range of 1230 to 1300 cm⁻¹, a maximum peak point of the maximum absorbance is observed between the bottom point at which the absorbance is the lowest (hereinafter referred to as “first bottom point”) and the bottom point at which the absorbance is the second lowest (hereinafter referred to as “second bottom point”). A line segment connecting the first bottom point and the second bottom point is referred to as a base line. The height P3 of the maximum peak point is the absolute value of the difference between the absorbance at the maximum peak point and the absorbance at the intersection point of the base line and the perpendicular line drawn from the maximum peak point toward the horizontal axis.

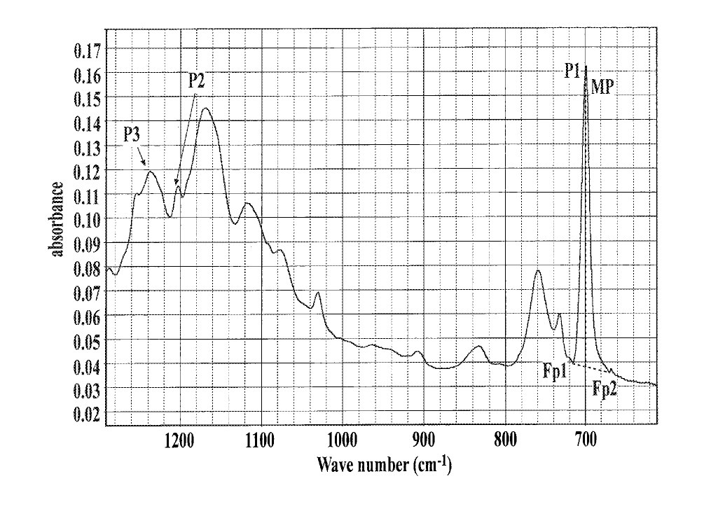

FIG. 1 is a graph showing an example spectrum observed by ATR.

In the present invention, particles composed of the toner base particles and external additives are referred to as toner particles, and aggregates of the toner particles are referred to as toner. In general, toner base particles also can be used as toner particles without additional treatment. In the present invention, however, external additives are added to the toner base particles to be used as toner particles.

### <Composition of Toner Base Particle>

The toner base particle in the present invention contains a styrene-acrylic resin, an amorphous polyester resin, and a crystalline polyester resin.

The styrene-acrylic resin, crystalline polyester resin, and amorphous polyester resin will now be described.

### <<Styrene-Acrylic Resin>>

The styrene-acrylic resin is synthesized with a styrene monomer and a (meth)acrylic monomer. Examples of the styrene monomer constituting the styrene-acrylic resin include styrene and styrene derivatives, such as o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene.

Examples of the (meth)acrylic monomer constituting the styrene-acrylic resin according to the present invention include acrylate monomers and methacrylate monomers, such as methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexylmethacrylate, ethyl 6-hydroxyethyl acrylate, γ-aminopropyl acrylate, stearyl methacrylate, dimethylaminoethyl methacrylate, and diethylaminoethyl methacrylate.

These polymerizable vinyl monomers, such as styrene monomers and (meth)acrylic monomers, may be used alone or in combination or may be used as copolymers with other monomers, such as acrylic acid, mathacrylic acid, maleic acid, itaconic acid, cinnamic acid, fumaric acid, monoalkyl maleate, monoalkyl itaconate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, and polyethylene glycol mono(meth)acrylate. The polymers can be produced by any known polymerization, for example, block polymerization, solution polymerization, emulsion polymerization, miniemulsion polymerization, suspension polymerization, or dispersion polymerization, with an appropriate polymerization initiator that is usually used in polymerization of monomers, such as a peroxide, a persulfide, or an azo compound. In addition, a chain-transfer agent, which is usually used, may be used for adjusting the molecular weight. Any chain transfer agent can be used, and examples thereof include alkyl mercaptans and mercapto fatty acid esters.

The amount of the styrene-acrylic resin in the toner of the present invention is preferably in a range of 50% to 90% by mass based on the total amount of the resins contained in the toner. A content of the styrene-acrylic resin of 50% by mass or more improves the dispersibility of coloring agent, leading to a higher image density. A significantly large amount of styrene-acrylic resin leads to a relatively small amount of crystalline polyester to counteract the effect of improving low-temperature fixability. Accordingly, the content of the styrene-acrylic resin should be 90% by mass or less.

The content of the styrene-acrylic resin is preferably in a range of 60% to 85% by mass.

The content of the styrene-acrylic resin herein indicates the sum of the content of the styrene-acrylic resin in the toner base particles and the content of the styrene-acrylic resin chemically bonded to a crystalline polyester resin unit or amorphous polyester resin unit in a hybrid structure of the crystalline polyester resin or amorphous polyester resin.

### <<Crystalline Polyester Resin>>

The term “crystalline” of crystalline polyester resin of the present invention means that the polyester resin has a clear endothermic peak, instead of stepwise endothermic change, in differential scanning calorimetry (DSC). Specifically, a polyester resin having a half-width of less than 10° C. in an endothermic peak at a heating rate of 10° C./min is referred to as a crystalline polyester resin.

The crystalline polyester resin is produced by polycondensation of a polyester forming composition composed of a polyvalent carboxylic acid (derivative) and a polyhydric alcohol (derivative).

Examples of the polyvalent carboxylic acid derivative include alkyl esters, acid anhydrides, and acid chlorides of polyvalent carboxylic acids. Examples of the polyhydric alcohol derivative include ester compounds of polyhydric alcohols and hydroxycarboxylic acids.

The polyvalent carboxylic acid refers to a compound having two or more carboxy groups in one molecule. Among polyvalent carboxylic acids, a divalent carboxylic acid has two carboxy groups in one molecule. Examples of such acid include oxalic acid, succinic acid, maleic acid, adipic acid, β-methyladipic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucic acid, phthalic acid, isophthalic acid, terephthalic acid, tetrachlorphthalic acid, chlorphthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1, 4-dicarboxylic acid, naphthalene-1,5-dicarboxylic acid, naphthalene-2, 6-dicarboxylic acid, anthracenedicarboxylic acid, and dodecenylsuccinic acid.

Examples of the polyvalent carboxylic acid other than divalent carboxylic acids include trimellitic acid, pyrromellitic acid, naphthalenetricarboxylic acid, naphthalenetetracarboxylic acid, pyrenetricarboxylic acid, and pyrenetetracarboxylic acid.

The polyhydric alcohol refers to a compound having two or more hydroxy groups in one molecule. Among polyhydric alcohols, a divalent polyol (diol) has two hydroxy groups in one molecule. Examples of the diol include ethylene glycol, propylene glycol, 1,4-butanediol, diethylene glycol, 1,6-hexanediol, 1,4-cyclohexanediol, 1,8-octanediol, 1,10-decanediol, 1,12-dodecanediol, ethylene oxide adducts of bisphenol A, and propylene oxide adducts of bisphenol A. Examples of the polyol other than divalent polyols include glycerin, pentaerythritol, hexamethylolmelamine, hexaethylolmelamine, tetramethylolbenzoguanamine, and tetraethylolbenzoguanamine.

The crystalline polyester resin particle preferably has a melting point Tm in a range of 65° C. to 90° C. and more preferably in a range of 70° C. to 85° C. A melting point Tm in a range of 65° C. to 90° C. contributes to the low-temperature fixability and enhanced heat-resistant storage properties of the toner.

### (Measurement of Melting Point of Crystalline Polyester Resin)

The melting point of crystalline polyester resin can be measured by differential scanning calorimetry (DSC).

For example, a DSC-7 differential scanning calorimeter (manufactured by PerkinElmer, Inc.) or a TAC7/DX thermal analysis controller (manufactured by PerkinElmer, Inc.) can be used for the measurement. Specifically, a sample (4.50 mg) is sealed in an aluminum pan (KIT No. 0219-0041) and is placed on the sample holder of the “DSC-7” calorimeter. An empty aluminum pan is used for the reference measurement. The temperature control of heating-cooling-heating is performed under the conditions of a measurement temperature of 0° C. to 200° C., a heating rate of 10° C./min, and a cooling rate of 10° C./min. Based on the data during the second heating step, the temperature at the top of the endothermic peak is determined as the melting point.

The crystalline polyester resin may be partially branched or cross-linked depending on, for example, selection of the valency of carboxylic acid and the valency of alcohol of polycondensable monomers.

The crystalline polyester resin according to the present invention may have a hybrid structure. A crystalline polyester resin having a hybrid structure is readily blended with a styrene-acrylic resin and barely exposes to the surface of toner base particle.

The crystalline polyester resin having a hybrid structure is composed of a crystalline polyester resin unit and a non-polyester resin unit chemically bonded to each other. The crystalline polyester resin unit refers to the moiety derived from a crystalline polyester resin, and the non-polyester resin unit refers to the moiety derived from a non-polyester resin. Examples of the non-polyester resin include vinyl resins, such as styrene-acrylic resins; urethane resins; and urea resins. The non-polyester resin unit may be derived from a single resin or multiple resins.

The amorphous polyester resin also may have a hybrid structure, like the crystalline polyester resin.

### <<Amorphous Polyester Resin>>

The amorphous polyester resin is produced by polycondensation of a polyvalent carboxylic acid (derivative) and a polyhydric alcohol (derivative) and has no distinct melting point.

The polyvalent carboxylic acid and the polyhydric alcohol as raw materials of the amorphous polyester resin may be those described as the raw materials of the crystalline polyester resin.

The ratio between the polyvalent carboxylic acid and the polyhydric alcohol is determined such that the equivalent ratio [OH]/[COOH] of the hydroxy group [OH] of the polyhydric alcohol to the carboxy group [COOH] of the polyvalent carboxylic acid is preferably in a range of 1.5/1 to 1/1.5 and more preferably in a range of 1.2/1 to 1/1.2.

The amorphous polyester resin preferably has a glass transition point in a range of 20° C. to 70° C.

The glass transition point of the amorphous polyester resin is measured in accordance with the method (DSC) specified in American Society for Testing and Material (ASTM) Standard D3418-82 using the amorphous polyester resin as a sample.

The toner base particle according to the present invention can contain a coloring agent, a release agent, a charge control agent, or another agent, as needed.

### <<Coloring Agent>>

Examples of the coloring agent that can be contained in the toner base particle include carbon black, magnetic materials, dyes, and pigments.

Examples of the carbon black include channel black, furnace black, acetylene black, thermal black, and lamp black.

Examples of the magnetic material include ferromagnetic metals, such as iron, nickel, and cobalt; alloys containing these metals; and compounds of ferromagnetic metals, such as ferrite and magnetite.

Usable examples of the pigment include C.I. Pigment Reds 2, 3, 5, 7, 15, 16, 48:1, 48:3, 53:1, 57:1, 81:4, 122, 123, 139, 144, 149, 166, 177, 178, 208, 209, and 222; C.I. Pigment Oranges 31 and 43; C.I. Pigment Yellows 3, 9, 14, 17, 35, 36, 65, 74, 83, 93, 94, 98, 110, 111, 138, 139, 153, 155, 180, 181, and 185; C.I. Pigment Green 7; C.I. Pigment Blues 15:3, 15:4, and 60; and phthalocyanine pigments having zinc, titanium, or magnesium as the central metals. These pigments may be used in the form of mixture. Usable examples of the dye include C.I. Solvent Reds 1, 3, 14, 17, 18, 22, 23, 49, 51, 52, 58, 63, 87, 111, 122, 127, 128, 131, 145, 146, 149, 150, 151, 152, 153, 154, 155, 156, 157, 158, 176, and 179; pyrazolotriazole azo dyes; pyrazolotriazole azomethine dyes; pyrazolone azo dyes; pyrazolone azomethine dyes; C.I. Solvent Yellows 19, 44, 77, 79, 81, 82, 93, 98, 103, 104, 112, and 162; C.I. Solvent Blues 25, 36, 60, 70, 93, and 95. These dyes may be used in the form of mixture.

The number-average primary particle diameter of the coloring agent varies depending on the type and is preferably approximately 10 to 200 nm.

The amount of the coloring agent contained in the toner base particle is preferably in a range of 1% to 30% by mass, more preferably 2% to 20% by mass, based on the total amount of the resins contained in the toner.

### <<Release Agent>>

The toner base particle according to the present invention may contain a wax as a release agent. Examples of the wax include hydrocarbon waxes, such as low-molecular-weight polyethylene wax, low-molecular-weight polypropylene wax, Fischer-Tropsch wax, microcrystalline wax, and paraffin wax; and ester waxes, such as carnauba wax, pentaerythritol behenate, pentaerythritol tetrastearate, behenyl behenate, and behenyl citrate. These release agents may be used alone or in combination.

The wax preferably has a melting point of 50° C. to 95° C., from the viewpoint of providing secure low-temperature fixability and releasability to the toner. The amount of the wax is preferably in a range of 2% to 20% by mass, more preferably 3% to 18% by mass, and most preferably 4% to 15% by mass based on the total amount of the resins contained in the toner.

The wax present in the toner base particle preferably forms an independent domain differentiated from the crystalline polyester resin. The formation of the independent domain readily allows the different domains to have their own functions. For example, in a case of producing a toner in an aqueous medium, a domain differentiated from the crystalline polyester resin can be readily formed by producing toner base particles using a wax coated with a resin. If the wax as a release agent is incompatible with the crystalline polyester resin and is present as an independent domain differentiated from the crystalline polyester resin in a matrix, the functions of the crystalline polyester resin and the wax can be sufficiently exhibited without being deteriorated, giving a toner having good low-temperature fixability, fixability and separability, and offset properties on rough paper.

The domain diameter of the wax is preferably in a range of 300 nm to 2 μm. Sufficient releasability can be maintained in this range.

### <<Charge Control Agent>>

The toner base particle according to the present invention can contain a variety of known charge control agents.

Many known compounds that can be dispersed in aqueous media are usable as charge control agents. Examples of the compound include nigrosine dyes, metal salts of naphthenic acid or higher fatty acid, alkoxylated amines, quaternary ammonium salt compounds, azo metal complexes, and metal salts or metal complexes of salicylic acid.

The amount of the charge control agent is preferably in a range of 0.1% to 10% by mass, more preferably 0.5% to 5% by mass, based on the total amount of the resins contained in the toner.

### <Average Circularity of Toner Base Particle>

The average circularity of the toner base particles used in the present invention will be described. The average circularity of the toner base particles used in the present invention is preferably in a range of 0.850 to 0.990.

The average circularity of the toner base particles herein is measured with a flow particle image analyzer “FPIA-2100” (manufactured by Sysmex Corporation).

Specifically, toner base particles are wetted with an aqueous surfactant solution and are dispersed with ultrasonic waves for 1 min. After the dispersion, measurement with the analyzer “FPIA-2100” is performed in a high power field (HPF, high magnification imaging) mode at an appropriate density of the HPF detection number of 3000 to 10000. Within this range, the measurement is reproducible. The circularity is calculated by the following expression:

Circularity=(perimeter of a circle having the same projected area as that of a particle image)/(perimeter of a projected image of the particle)

The average circularity is an arithmetic mean value determined by summing the degrees of circularity of particles and dividing the sum by the number of the measured particles.

### <Diameter of Toner Particle>

The diameter of the toner particles used in the present invention will now be described. The toner particles used in the present invention preferably have a volume-average diameter (D₅₀% diameter), i.e., volume-based median diameter, of 3 μm or more and 10 μm or less.

A volume-based median diameter within the above-mentioned range allows faithful reproduction of a significantly fine dot image, for example, a 1200 dpi (dots per inch (2.54 cm)) level.

The volume-based median diameter (D₅₀% diameter) of toner particles can be measured and calculated as described above, for example, with a “Multisizer 3” system (manufactured by Beckman Coulter, Inc.) connected to a computer system (manufactured by Beckman Coulter, Inc.) loaded with data processing software “Software V 3.51”.

The procedure is as follows: Toner particles (0.02 g) are wetted with a surfactant solution (20 mL, for example, a surfactant solution, prepared by diluting a neutral detergent containing a surfactant component ten-fold with pure water, for dispersing the toner particles) and are dispersed with ultrasonic waves for 1 min to produce a toner particle dispersion. This toner particle dispersion is poured, with a pipette, into a beaker containing ISOTON II (manufactured by Beckman Coulter, Inc.) placed in a sample stand to give a measurement concentration of 5% to 10%, followed by measurement with a counter that has been set to a count of 25000. The Multisizer 3 system has an aperture diameter of 100 μm. The measured range of 2 to 60 μm is divided into 256 fractions, and frequency in each fraction is calculated. The particle diameter at 50% of the volume-integrated fraction from the larger side is defined as the volume-based median diameter (D₅₀% diameter).

The diameter of toner base particles can also be similarly measured.

### <Softening Point of Toner>

The toner of the present invention preferably has a softening point in a range of 90° C. to 120° C. Toner having a softening point in this range can have favorable low-temperature fixability.

The softening point can be measured with “Flow tester CFT-500D” (manufactured by Shimadzu Corporation).

### [Production of Toner]

### <Production of Toner Base Particle>

The toner base particles of the present invention can be produced by, for example, pulverization, suspension polymerization, miniemulsion polymerization, emulsion aggregation, or any other known process. Preferred are miniemulsion polymerization and emulsion aggregation.

Preferred is production of toner base particles through preparation of a polyester resin by miniemulsion polymerization, which process can reduce exposure of a crystalline polyester resin to the surface of toner base particle e.

Emulsion aggregation, which can readily reduce the diameter of toner particles, is preferred from the viewpoint of manufacturing cost and manufacturing stability.

In the miniemulsion polymerization, oil droplets (10 to 1000 nm) of a polymerizable monomer solution of a crystalline polyester resin, a release agent, and other components dissolved in a polymerizable monomer are formed by means of mechanical energy in an aqueous medium of a surfactant dissolved at a concentration of not higher than the aqueous solvent critical micelle concentration to prepare a dispersion. A water-soluble polymerization initiator is added to the resulting dispersion for radical polymerization. The resulting polymer fine particles are associated (aggregation and fusion) to prepare toner base particles.

In the emulsion aggregation, particles of a resin (hereinafter, also referred to as “resin particles”) are emulsified to produce a dispersion. The dispersion is mixed with a dispersion of particles of a coloring agent (hereinafter, also referred to as “coloring agent particles”), as needed, followed by aggregation into a desired toner particle diameter and fusion of the resin particles for control of the particle shape. Toner base particles are thereby produced. Herein, the resin particles may appropriately contain a release agent, a charge control agent, or another agent.

A process of producing the toner base particles of the present invention by emulsion aggregation will now be described. An aqueous dispersion of styrene-acrylic resin particles, an aqueous dispersion of crystalline polyester resin particles, an aqueous dispersion of amorphous polyester resin particles, and an aqueous dispersion of coloring agent particles are mixed to aggregate and fuse the particles into toner base particles of the present invention.

An example of production by emulsion aggregation of toner base particles containing a coloring agent of the present invention specifically includes:

(a) a step of preparing a dispersion of styrene-acrylic resin particles in an aqueous medium;

(b) a step of preparing a dispersion of crystalline polyester resin particles in an aqueous medium;

(c) a step of preparing a dispersion of amorphous polyester resin particles in an aqueous medium;

(d) a step of preparing a dispersion of coloring agent particles in an aqueous medium;

(e) an aggregation and fusion step by mixing the dispersion of styrene-acrylic resin particles, the dispersion of crystalline polyester resin particles, the dispersion of amorphous polyester resin particles, and the dispersion of coloring agent particles to aggregate the crystalline polyester resin particles, the styrene-acrylic resin particles, and the coloring agent particles, and then fusing the aggregated particles by thermal energy;

(f) a step of aging the aggregated particles by thermal energy after step (e) for controlling the shape of the toner base particles to prepare an aqueous dispersion of the toner base particles; and

(g) a step of cooling the aqueous dispersion of the toner base particles.

The toner base particles of the present invention produced in an aqueous medium as described above can have a narrow toner particle diameter distribution, leading to a higher quality image.

In step (b), the crystalline polyester resin may be chemically bonded to a non-polyester resin unit, such as a styrene-acrylic resin, to form a hybrid structure. The crystalline polyester resin having a hybrid structure barely exposes to the surface of toner base particle.

After step (g), the toner base particles are collected from the aqueous dispersion of the toner base particles by filtration and are subjected to a washing step for removing the surfactant and other agents from the toner base particles and a drying step for drying the washed toner base particles. The dried toner base particles are optionally subjected to an external additive-treating step of adding an external additive to the toner base particles. Toner particles can be thereby produced.

### <<Step of Preparing Dispersion of Styrene-Acrylic Resin Particles>>

The dispersion of styrene-acrylic resin particles can be prepared by emulsion polymerization.

In the step of polymerizing a styrene-acrylic resin in the presence of a surfactant, the surfactant may be, for example, the same as that used in the step of preparing a dispersion of crystalline polyester resin particles, described below.

### <<Step of Preparing Dispersion of Crystalline Polyester Resin Particles>>

This step preferably involves the following substeps.

(A-1) a substep of synthesizing a crystalline polyester resin;

(A-2) a substep of a preparing crystalline polyester resin solution; and

(A-3) a substep of removing solvent.

### (A-1) Substep of Synthesizing Crystalline Polyester Resin

The crystalline polyester resin may be produced by any method and can be produced by usual polyester polymerization through reaction of a polyvalent carboxylic acid and a polyhydric alcohol. For example, direct polycondensation or transesterification is employed depending on the type of monomer.

Examples of the catalyst usable in the production of a crystalline polyester resin include alkali metal compounds of, for example, sodium and lithium; alkaline earth metal compounds of, for example, magnesium and calcium; metal compounds of, for example, zinc, manganese, antimony, titanium, tin, zirconium, and germanium; phosphorous compounds; phosphate compounds; and amine compounds. Specifically, examples of the catalyst include the following compounds:

Sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin oxalate, tetraphenyltin, dibutyltin dichloride, dibutyltin oxide, diphenyltin oxide, zirconium tetrabutoxide, zirconium naphthenate, zirconium carbonate, zirconium acetate, zirconium stearate, zirconium octylate, germanium oxide, triphenyl phosphite, tris(2,4-t-butylphenyl) phosphite, ethyltriphenylphosphonium bromide, triethylamine, and triphenylamine.

### (A-2) Substep of Preparing Crystalline Polyester Resin Solution

In substep (A-2), the synthesized crystalline polyester resin is dissolved in an organic solvent to prepare a crystalline polyester resin solution. The crystalline polyester solution is then emulsion-dispersed in an aqueous medium to form oil droplets of the crystalline polyester solution.

In substep (A-2), preferably, the crystalline polyester resin solution is gradually added to an aqueous medium. Alternatively, phase inversion emulsification by gradual addition of an aqueous medium to the crystalline polyester resin solution may be employed.

### (Organic Solvent)

Any organic solvent that can dissolve the crystalline polyester resin can be used. Preferred examples of the organic solvent include ethyl acetate, methyl ethyl ketone, and toluene.

### (Aqueous Medium)

In this embodiment, the term “aqueous medium” refers to a medium composed of 50% to 100% by mass of water and 0% to 50% by mass of a water-soluble organic solvent. Examples of the water-soluble organic solvent include methanol, ethanol, isopropanol, butanol, acetone, methyl ethyl ketone, and tetrahydrofuran. An alcohol organic solvent that does not dissolve the resin is preferably used.

The aqueous medium may contain an amine or ammonia in a dissolved state, as needed.

### (Surfactant)

The aqueous medium may contain a common surfactant, such as cationic surfactant, anionic surfactant, amphoteric surfactant, or nonionic surfactant, in a dissolved state, as needed. The surfactant is preferably an anionic surfactant, which provides excellent dispersion stability to oil droplets of the crystalline polyester resin and has stability against a change in temperature.

Examples of the anionic surfactant include higher fatty acid salts, such as sodium oleate; alkylarylsulfonates, such as sodium dodecylbenzenesulfate; alkyl sulfates, such as sodium lauryl sulfate; polyoxyethylene alkyl ether sulfates, such as sodium polyoxyethylene lauryl ether sulfate and sodium polyethoxyethylene lauryl ether sulfate; polyoxyethylene alkyl aryl ether sulfates, such as sodium polyoxyethylene nonyl phenyl ether sulfate; alkyl sulfosuccinates, such as sodium monooctyl sulfosuccinate, sodium dioctyl sulfosuccinate, and sodium polyoxyethylene lauryl sulfosuccinate; and derivatives thereof.

These surfactants may be used alone or in combination according to requirements.

Specifically, the emulsion dispersion is performed by application of mechanical energy. The mechanical energy may be applied with any disperser, such as a stirring apparatus provided with a rotor rotatable at a high speed, an ultrasonic dispersion apparatus, a mechanical homogenizer, a Manton-Gaulin homogenizer, or a pressure homogenizer.

### (A-3) Substep of Removing Solvent

In substep (A-3), the organic solvent is distilled off from the oil droplets formed in substep (A-2) to generate particles of the crystalline polyester resin. A dispersion of the crystalline polyester resin particles is thereby prepared.

Specifically, the organic solvent is preferably distilled off under the conditions of a degree of vacuum of 400 to 50000 Pa and a temperature in a range of 30° C. to 50° C.

The crystalline polyester resin particles preferably have a particle diameter, for example, in a range of 30 to 500 nm as the volume-based median diameter.

The diameter of crystalline polyester resin particles is measured with “Microtrac UPA-150” (manufactured by Nikkiso Co., Ltd.) by dynamic light scattering.

The weight-average molecular weight of the crystalline polyester resin measured by gel permeation chromatography (GPC) is preferably in a range of 5000 to 100000 and more preferably in a range of 10000 to 50000.

A molecular weight of 5000 or more reduces the compatibilization of the crystalline polyester resin with the styrene-acrylic resin to prevent a reduction in heat resistance. A molecular weight of 100000 or less can maintain proper low-temperature fixability.

### <<Step of Preparing Dispersion of Fine Particles of Amorphous Polyester Resin>>

This step preferably involves the following substeps.

(B-1) a substep of synthesizing amorphous polyester resin;

(B-2) a substep of preparing amorphous polyester resin solution; and

(B-3) a substep of removing solvent.

The specific synthesis, preparation, and removal of solvent in substeps (B-1) to (B-3) are substantially the same as those in substeps (A-1) to (A-3) in the preparation of crystalline polyester dispersion, and the descriptions thereof are omitted.

The amorphous polyester resin fine particles preferably have a particle diameter in a range of 50 to 300 nm as the volume-based median diameter.

The particle diameter of the fine particles of the amorphous polyester resin is measured with “Micronanotrac UPA-EX150” (manufactured by Nikkiso Co., Ltd.) by dynamic light scattering.

The weight-average molecular weight of the amorphous polyester resin measured by gel permeation chromatography (GPC) is preferably in a range of 5000 to 100000 and more preferably in a range of 5000 to 50000.

A molecular weight of 5000 or more prevents deterioration of heat-resistant storage properties. A molecular weight of 100000 or less can maintain proper low-temperature fixability.

### <<Step of Preparing Dispersion of Coloring Agent Particles>>

A dispersion of coloring agent particles can be prepared by dispersing a coloring agent in an aqueous medium. The dispersion treatment is preferably performed by dispersing the coloring agent in the aqueous medium containing a surfactant at a concentration not lower than the critical micelle concentration (CMC) for uniform dispersion of the coloring agent. The disperser used for the dispersion treatment of the coloring agent may be any known disperser.

The coloring agent particles in the dispersion prepared by this step preferably has a diameter in a range of 10 to 300 nm as the volume-based median diameter.

The volume-based median diameter of the coloring agent particles in the coloring agent particle dispersion is measured with “Micronanotrac UPA-150” (manufactured by Nikkiso Co., Ltd.) by dynamic light scattering.

### <<Aggregation and Fusion Step>>

In the aggregation and fusion step, optionally, particles of an offset inhibitor, such as a release agent, and other toner components, such as a charge control agent, also can be aggregated together with the styrene-acrylic resin particles, the crystalline polyester resin particles, the amorphous polyester resin particles, and the coloring agent particles.

Specifically, the styrene-acrylic resin particles, the crystalline polyester resin particles, the amorphous polyester resin particles, and the coloring agent particles in an aqueous medium are aggregated and fused by adding a flocculant to the aqueous medium at a critical aggregation concentration or more and then heating the particles at a temperature of not lower than the glass transition points of the resin particles and not higher than the melt peak temperature of the mixture to accelerate the salting out and simultaneously promote the fusion of the particles, i.e., the styrene-acrylic resin particles, the crystalline polyester resin particles, the amorphous polyester resin particles, and the coloring agent particles. The particle growth is then stopped at a desired particle diameter by addition of an aggregation terminator, and heating is further continued as needed for controlling the particle shape.

In the aggregation and fusion step in the present invention, the amorphous polyester resin particle dispersion is preferably fed subsequent to the feed of the crystalline polyester resin particle dispersion and the styrene-acrylic resin particle dispersion. Specifically, the crystalline polyester resin particle dispersion and the styrene-acrylic resin particle dispersion are preferably fed as a first-stage dispersion, and the amorphous polyester resin dispersion is preferably fed as a second-stage dispersion.

The feed of the amorphous polyester resin particle dispersion subsequent to the feed of the crystalline polyester resin particle dispersion and the styrene-acrylic resin particle dispersion provides a ratio (P3/P1) in a range of 0.02 to 6.00 and can optimize the amounts of the amorphous polyester resin and the styrene-acrylic resin present in the vicinity of the surface of toner base particle.

### (Flocculant)

The aggregation and fusion step can use any flocculant, and the flocculant is preferably selected from metal salts.

Examples of the metal salt include monovalent metal salts, e.g., alkali metal salts of, for example, sodium, potassium, and lithium; divalent metal salts of, for example, calcium, magnesium, manganese, and copper; and trivalent metal salts of, for example, iron and aluminum.

Examples of the metal salts include sodium chloride, potassium chloride, lithium chloride, calcium chloride, magnesium chloride, zinc chloride, copper sulfate, magnesium sulfate, and manganese sulfate. Among these metal salts, preferred are divalent metal salts, which can promote aggregation in a smaller amount. These metal salts may be used alone or in combination.

The toner base particles prepared in the aggregation and fusion step preferably have a particle diameter, for example, in a range of 2 to 9 μm, more preferably 4 to 7 μm, as the volume-based median diameter (D₅₀% diameter).

The volume-based median diameter of the toner base particles is measured with a particle size distribution measuring apparatus “Multisizer 3” (manufactured by Beckman Coulter, Inc.).

### <<Aging Step>>

Although the shape of the toner base particles in toner can be uniformized to some extent by controlling the heating temperature in the aggregation and fusion step, an aging step is preferably performed for further uniformization of the shape.

The aging step controls the heating temperature and time such that the toner base particles having uniform particle diameter with a narrow distribution have surfaces being smooth and having uniform shape. Specifically, the aggregation and fusion step is performed at a low heating temperature to inhibit the promotion of fusion of resin particles and to accelerate the uniformization. The aging step is also performed at a low heating temperature for a long time to give toner base particles having desired average circularity, i.e., having uniform surface shape.

### <<Cooling Step>>

The cooling step cools the aqueous dispersion of the toner base particles after the aging step. In the present invention, the cooling rate of the aqueous dispersion of the toner base particles is preferably in a range of 10° C./min to 30° C./min. Such a cooling rate precludes recrystallization of the crystalline polyester resin, decreasing the peak intensity ratio (P2/P1) to 0.20 or less.

### <<Washing and Drying Step>>

The washing and drying step may be performed by any known process. That is, toner base particles are matured in the aging step to give desired average circularity and are cooled in the cooling step. Solid-liquid separation is then performed by a known process, such as centrifugation, followed by washing. The organic solvent is removed by drying under reduced pressure. Moisture and a trace of the organic solvent are removed with a known dryer, such as a flash jet dryer or fluidized bed drying apparatus. The drying may be performed at any temperature not fusing the toner base particles.

### <<External Additive Treating Step>>

In the external additive treating step, external additives are added to and mixed with the dried toner base particles, as needed, to prepare toner particles.

Although the toner base particles produced through the steps until the drying step can be used as toner particles without additional treatment, particles, such as known inorganic fine particles or organic fine particles, and a lubricant are preferably applied to the surfaces of the toner base particles as external additives from the viewpoint of improving the charging performance and fluidity as toner or cleaning properties.

The external additives may be used in combination.

Examples of the inorganic fine particles include fine particles of inorganic oxides, such as silica, alumina, and titanium oxide fine particles; fine particles of inorganic stearate compounds, such as aluminum stearate and zinc stearate fine particles; and fine particles of inorganic titanate compounds, such as strontium titanate and zinc titanate fine particles.

These inorganic fine particles are preferably surface-treated with, for example, a silane coupling agent, titanium coupling agent, higher fatty acid, or silicone oil, from the viewpoint of heat-resistant storage properties and environmental stability.

The content of such an external additive is in a range of 0.05 to 5 parts by mass, preferably 0.1 to 3 parts by mass, based on 100 parts by mass of the toner base particles.

The external additive may be added to the dried toner base particles by, for example, a dry process, that is, the external additive in a powder form is added to the toner base particles. The apparatus for mixing is, for example, a mechanical mixing apparatus, such as a Henschel mixer or coffee mill.

### [Developer]

The toner of the present invention can also be used as a magnetic or nonmagnetic one component developer or may be mixed with a carrier and be used as a two component developer.

The carrier can be magnetic particles made of known materials, e.g., metals, such as iron, ferrite, and magnetite; and alloys of these metals and other metals, such as aluminum and lead. Among these carriers, ferrite particles are preferred. The carrier may also be a coat carrier composed of magnetic particles having surfaces coated with a coating agent, such as a resin, or a resin distribution type carrier composed of magnetic material fine particles dispersed in a binder resin.

The carrier preferably has a volume-average particle diameter in a range of 15 to 100 μm and more preferably in a range of 25 to 80 μm.

### EXAMPLES

The present invention will now be described in detail by examples, which should not be intended to limit the present invention. It is noted that “part(s)” and “%” in examples indicate “part(s) by mass” and “% by mass”, respectively, unless defined otherwise.

### [Production of Resin Particle Dispersion]

### <Styrene-Acrylic Resin Particle Dispersion>

### (First-Stage Polymerization)

An aqueous solution of an anionic surfactant, sodium dodecylsulfate (C₁₀H₂₁(OCH₂CH₂)₂SO₃Na, 4 parts by mass), in deionized water (3040 parts by mass) was fed in a reaction vessel equipped with a stirrer, a temperature sensor, a cooling tube, and a nitrogen-introducing tube. A solution of a polymerization initiator, potassium persulfate (KPS, 10 parts by mass), in deionized water (400 parts by mass) was added to the vessel. The solution was heated to 75° C., and a polymerizable monomer solution consisting of styrene (532 parts by mass), n-butylacrylate (200 parts by mass), methacrylic acid (68 parts by mass), and n-octyl mercaptan (16.4 parts by mass) was dropwise fed to the vessel for 1 hour, followed by heating at 75° C. for 2 hours with stirring for polymerization (first-stage polymerization). A resin particle dispersion (1H) containing resin particles (1h) was thereby prepared.

The resulting resin particles (1h) had a weight-average molecular weight of 16500.

### (Second-Stage Polymerization)

A polymerizable monomer solution consisting of styrene (101.1 parts by mass), n-butyl acrylate (62.2 parts by mass), methacrylic acid (12.3 parts by mass), and n-octyl mercaptan (1.75 parts by mass) was fed in a flask equipped with a stirrer. Paraffin wax “HNP-57” (manufactured by Nippon Seiro Co., Ltd., 93.8 parts by mass) was then added to the flask and was melted by raising the internal temperature to 90° C. A monomer solution was thereby prepared.

Separately, an aqueous solution of the anionic surfactant (3 parts by mass) used in the first-stage polymerization in deionized water (1560 parts by mass) was fed in a flask, and the internal temperature was raised to 98° C. The resin particles (1h, 32.8 parts by mass in terms of solid content) prepared in the first-stage polymerization were added to the aqueous surfactant solution. A monomer solution containing the paraffin wax was further added to the aqueous surfactant solution, followed by mixing and dispersing with a mechanical disperser “Clearmix” (manufactured by M Technique Co., Ltd.) having a circulation passage for 8 hours. A dispersion containing emulsified particles (oil droplets) having a particle diameter of 340 nm was thereby prepared.

Subsequently, a solution of a polymerization initiator, potassium persulfate (6 parts by mass), in deionized water (200 parts by mass) was added to the emulsified particle dispersion. This system was heated at 98° C. for 12 hours with stirring for polymerization (second-stage polymerization). A resin particle dispersion (1HM) containing resin particles (1hm) was thereby prepared.

The resulting resin particles (1hm) had a weight-average molecular weight of 23000.

### (Third Stage Polymerization)

A solution of a polymerization initiator, potassium persulfate (5.45 parts by mass), in deionized water (220 parts by mass) was added to the resin particle dispersion (1HM) prepared in the second-stage polymerization. To this mixture dropwise added was a polymerizable monomer solution consisting of styrene (293.8 parts by mass), n-butyl acrylate (154.1 parts by mass), and (n-octyl mercaptan (7.08 parts by mass) at a temperature of 80° C. for 1 hour. After the completion of the dropping, heating and stirring were performed for 2 hours for polymerization (third stage polymerization), followed by cooling to 28° C. A dispersion containing resin particles for core particles was thereby prepared.

The resulting resin particles for core particles had a weight-average molecular weight of 26800.

### <Crystalline Polyester Resin Particle Dispersion>

### (Production of Crystalline Polyester)

The following raw material monomers, including a bireactive monomer, for an addition polymerization resin (styrene-acrylic resin: St/Ac) unit and a radical polymerization initiator were placed in a dropping funnel.

styrene: 34 parts by mass,

n-butyl acrylate: 12 parts by mass,

acrylic acid: 2 parts by mass, and

polymerization initiator (di-t-butyl peroxide): 7 parts by mass.

The following raw material monomers for a polycondensation resin (crystalline polyester resin: CPEs) unit were placed in a four-necked flask equipped with a nitrogen-introducing tube, a dewatering tube, a stirrer, and a thermocouple and were heated for melting at 170° C.

sebacic acid: 290 parts by mass, and

1,12-dodecanediol: 292 parts by mass.

Subsequently, raw material monomers for an addition polymerization resin (St/Ac) were dropwise added to the flask for 90 min with stirring and were aged for 60 min. Unreacted addition polymerization monomers were removed under reduced pressure (8 kPa). The amount of the monomers removed on this occasion was very small relative to that of the raw material monomers for the resin.

Subsequently, an esterification catalyst, Ti(OBu)₄ (0.8 parts by mass), was fed to the flask, and the temperature was increased to 235° C., followed by reaction under an ordinary pressure (101.3 kPa) for 5 hours and then under a reduced pressure (8 kPa) for 1 hour.

Subsequently, the temperature was decreased to 200° C., followed by reaction under a reduced pressure (20 kPa) for 1 hour to give a crystalline polyester resin having a hybrid structure. DSC of this crystalline polyester resin at 10° C./min showed a clear peak with a peak top temperature of 77° C. having a half-width of 8° C.

### (Production of Crystalline Polyester Resin Particle Dispersion)

The crystalline polyester resin (30 parts by mass) produced in the above was melted, and the resin in the melted state was transferred to an emulsifying disperser “Cavitron CD1010” (manufactured by Eurotec) at a transfer rate of 100 parts by mass per minute. Concurrently with the transfer of the crystalline polyester resin in the melted state, a dilute ammonia solution having a concentration of 0.37% by mass was transferred to the emulsifying disperser at a transfer rate of 0.1 L per minute while being heated to 100° C. with a heat exchanger. The dilute ammonia solution was prepared in an aqueous solvent tank by diluting a reagent ammonia water (70 parts by mass) with deionized water. The emulsifying disperser was operated under conditions of a rotation rate of the rotor of 60 Hz and a pressure of 5 kg/cm² to prepare a crystalline polyester resin particle dispersion having a volume-based median diameter of 200 nm and a solid content of 30 parts by mass.

### <Amorphous Polyester Resin Particle Dispersion>

### (Production of Amorphous Polyester Resin)

A four-necked flask equipped with a nitrogen-introducing tube, a dewatering tube, a stirrer, and a thermocouple was fed with

Bisphenol A propylene oxide 2-mol adduct: 285.7 parts by mass,

terephthalic acid: 66.9 parts by mass,

fumaric acid: 47.4 parts by mass, and

esterification catalyst (tin octylate): 1.43 parts by mass.

The mixture was subjected to polycondensation at 230° C. for 8 hours and then to reaction at 8 kPa for 1 hour, and then cooled to 160° C. A mixture of

acrylic acid: 10 parts by mass,

styrene: 80 parts by mass,

butyl acrylate: 20 parts by mass, and

polymerization initiator (di-t-butyl peroxide): 16 parts by mass

was dropwise added from a dropping funnel to the reaction mixture for 1 hour. The addition polymerization was further continued at 160° C. for 1 hour. The reaction mixture was heated to 200° C. and was maintained under 10 kPa for 1 hour. The styrene and butyl acrylate were then removed to give an amorphous polyester resin having a hybrid structure.

The amorphous polyester resin had a glass transition point of 60° C.

### (Production of Amorphous Polyester Resin Particle Dispersion)

The amorphous polyester resin (100 parts by mass) produced in the above was pulverized with “Roundel Mill, model: RM” (manufactured by Tokuju Corporation) and was mixed with a 0.26% by mass sodium laurylsulfate solution (638 parts by mass). The mixture was dispersed with ultrasonic waves using an ultrasonic homogenizer “US-150T” (manufactured by Nihonseiki Kaisha Ltd.) at V-LEVEL and 300 μA for 30 min with stirring to disperse the amorphous polyester resin particles having a volume-based median diameter (D50V) of 180 nm. An amorphous polyester resin particle dispersion was thereby produced.

### <Coloring Agent Particle Dispersion>

Sodium dodecylsulfate (90 parts by mass) was dissolved in deionized water (1600 parts by mass) with stirring. Carbon black “Regal 330R” (manufactured by Cabot Corporation, 420 parts by mass) was gradually added to this solution with stirring, followed by dispersion treatment with a stirrer “Clearmix” (manufactured by M Technique Co., Ltd.) to prepare a dispersion of coloring agent particles. The coloring agent particles had a diameter of 117 nm based on the measurement with UPA (manufactured by MicrotracBEL Corp.).

### [Production of Toner]

### <Production of Toner 1>

### (Steps of Aggregation and Fusion, Aging, and Cooling)

The “styrene-acrylic resin particle dispersion” (420 parts by mass in terms of solid content), the “crystalline polyester resin particle dispersion” (90 parts by mass in terms of solid content), and the “coloring agent particle dispersion” (48 parts by mass in terms of solid content) were fed, as the dispersions in the first-stage feeding, to a 5-L stainless steel reactor equipped with a stirrer, a cooling tube, and a temperature sensor. Deionized water (380 parts by mass) was further fed to the reactor, and the pH of the mixture was adjusted to 10 with an aqueous solution of 5 mol/L sodium hydroxide with stirring.

Subsequently, an aqueous magnesium chloride solution prepared by dissolving magnesium chloride hexahydrate (40 parts by mass) in deionized water (40 parts by mass) was dropwise added to the reactor for 10 min with stirring, followed by heating to an internal temperature of 75° C. The particle diameter was measured with a Multisizer 3 system (manufactured by Beckman Coulter, Inc., aperture diameter: 50 μm), and the “amorphous polyester resin particle dispersion” (90 parts by mass in terms of solid content) was dropwise added, as the dispersion in the second-stage feeding, to the reactor after the average particle diameter reached 5.8 μm. The heating and stirring were continued until the amorphous polyester resin particles adhered to the surfaces of the aggregated particles. A small amount of this reaction solution was centrifuged with a centrifugal separator, and after the supernatant became transparent, an aqueous sodium chloride solution prepared by dissolving sodium chloride (160 parts by mass) in deionized water (640 parts by mass) was added to the reactor. The heating and stirring were further continued. After the average circularity measured with a flow particle image analyzer “FPIA-2100” (manufactured by Sysmex Corp.) reached 0.960, the internal temperature was decreased to 25° C. at a rate of 20° C./min. A dispersion of “toner base particle 1” was thereby prepared.

### (Washing and Drying Step)

The dispersion of the toner base particle 1 generated in the aggregation and fusion, aging, and cooling step was solid-liquid separated with a basket-type centrifugal separator to form a wet cake of the toner base particles. The wet cake was washed with the basket-type centrifugal separator using deionized water of 35° C. until the electric conductivity of the filtrate reached 5 μS/cm and was then dried with a “flash jet dryer (manufactured by Seishin Enterprise Co., Ltd.)” until the water content was decreased to 0.5% by mass. “Toner base particle 1” was thereby produced.

### (External Additive Treating Step)

Hydrophobic silica (number-average primary particle diameter: 12 nm, 1 part by mass) and hydrophobic titania (number-average primary particle diameter: 20 nm, 0.3 parts by mass) were added to the “toner base particle 1” (100 parts by mass). The mixture was mixed with a Henschel mixer to produce toner 1.

### <Production of Toner 2>

Toner 2 was produced as in the production of toner 1 except that the cooling rate in the aggregation and fusion, aging, and cooling step was 25° C./min.

### <Production of Toner 3>

Toner 3 was produced as in the production of toner 1 except that the cooling rate in the aggregation and fusion, aging, and cooling step was 11° C./min.

### <Production of Toner 4>

Toner 4 was produced as in the production of toner 1 except that the cooling rate in the aggregation and fusion, aging, and cooling step was 7° C./min.

### <Production of Toner 5>

In the aggregation and fusion, aging, and cooling step in the production of toner 1, the “amorphous polyester resin particle dispersion” (90 parts by mass in terms of solid content), as the dispersion in the second-stage feeding, was dropwise added to the reactor after the average particle diameter reached 4 μm. The heating and stirring were continued until the amorphous polyester resin particles adhered to the surfaces of the aggregated particles. A small amount of this reaction solution was centrifuged with a centrifugal separator, and after the supernatant became transparent, the average particle diameter was further increased to 5.8 μm. An aqueous sodium chloride solution prepared by dissolving sodium chloride (160 parts by mass) in deionized water (640 parts by mass) was added to the reactor. The heating and stirring were further continued. After the average circularity measured with a flow particle image analyzer “FPIA-2100” (manufactured by Sysmex Corp.) reached 0.960, the internal temperature was decreased to 25° C. at a rate of 20° C./min. A dispersion of “toner base particle 5” was thereby prepared. Subsequently, the washing and drying step and the external additive treating step were performed as in the production of toner 1 to produce toner 5.

### <Production of Toner 6>

In the aggregation and fusion, aging, and cooling step in the production of toner 1, after the average particle diameter reached 5.8 μm, the heating and stirring were continued. After the average circularity measured with a flow particle image analyzer “FPIA-2100” (manufactured by Sysmex Corp.) reached 0.922, the “amorphous polyester resin particle dispersion” (90 parts by mass in terms of solid content), as the dispersion in the second-stage feeding, was dropwise added to the reactor. The heating and stirring were continued until the amorphous polyester resin particles adhered to the surfaces of the aggregated particles. A small amount of this reaction solution was centrifuged with a centrifugal separator, and after the supernatant became transparent, an aqueous sodium chloride solution prepared by dissolving sodium chloride (160 parts by mass) in deionized water (640 parts by mass) was added to the reactor. The heating and stirring were further continued. After the average circularity reached 0.960, the internal temperature was decreased to 25° C. at a rate of 20° C./min. A dispersion of “toner base particle 6” was thereby prepared. Subsequently, the washing and drying step and the external additive treating step were performed as in the production of toner 1 to produce toner 6.

### <Production of Toner 7>

Toner 7 was produced as in the production of toner 6 except that the dispersion in the second-stage was fed after the average circularity reached 0.933 instead of 0.922.

### <Production of Toner 8>

Toner 8 was produced as in the production of toner 6 except that the dispersion in the second-stage was fed after the average circularity reached 0.947 instead of 0.922.

### <Production of Toner 9>

Toner 9 was produced as in the production of toner 1 except that the amount of the “styrene-acrylic resin particle dispersion” in the first-stage feeding was 330 parts by mass in terms of solid content instead of 420 parts by mass and that the amount of the “amorphous polyester resin particle dispersion” in the second-stage feeding was 180 parts by mass in terms of solid content instead of 90 parts by mass.

### <Production of Toner 10>

Toner 10 was produced as in the production of toner 1 except that the amount of the “styrene-acrylic resin particle dispersion” in the first-stage feeding was 210 parts by mass in terms of solid content instead of 420 parts by mass and that the amount of the “amorphous polyester resin particle dispersion” in the second-stage feeding was 300 parts by mass in terms of solid content instead of 90 parts by mass.

### <Production of Toner 11>

Toner 11 was produced as in the production of toner 1 except that the amount of the “styrene-acrylic resin particle dispersion” was 570 parts by mass in terms of solid content instead of 420 parts by mass and the amount of the “crystalline polyester resin particle dispersion” was 10 parts by mass in terms of solid content instead of 90 parts by mass in the first-stage feeding and that the amount of the “amorphous polyester resin particle dispersion” in the second-stage feeding was 20 parts by mass in terms of solid content instead of 90 parts by mass.

### <Production of Toner 12> (Comparative Example)

Toner 12 was produced as in the production of toner 1 except that the “amorphous polyester resin particle dispersion” used as the dispersion in the second-stage feeding was dropwise added in an amount of 90 parts by mass in terms of solid content as the dispersion in the first-stage feeding.

### <Production of Toner 13> (Comparative Example)

In the aggregation and fusion, aging, and cooling step in the production of toner 1, an aqueous sodium chloride solution prepared by dissolving sodium chloride (160 parts by mass) in deionized water (640 parts by mass) was added to the reactor after the average particle diameter reached 5.8 μm. The heating and stirring were further continued. After the average circularity measured with a flow particle image analyzer “FPIA-2100” (manufactured by Sysmex Corp.) reached 0.960, the “amorphous polyester resin particle dispersion” (90 parts by mass in terms of solid content) as the dispersion in the second-stage feeding was dropwise added, followed by heating and stirring until the amorphous polyester resin particles adhered to the surfaces of the aggregated particles. A small amount of this reaction solution was centrifuged with a centrifugal separator. After the supernatant became transparent, the internal temperature was decreased to 25° C. at a rate of 20° C./min to give a dispersion of “toner base particle 13”. Subsequently, the washing and drying step and the external additive treating step were performed as in the production of toner 1 to produce toner 13.

### <Production of Toner 14> (Comparative Example)

Toner 14 was produced as in the production of toner 13 except that the cooling rate in the aggregation and fusion, aging, and cooling step was 4° C./min.

Table 1 shows “the amount (% by mass) of the styrene-acrylic resin”, “cooling rate (° C./min)”, and “the timing of feeding of the amorphous polyester resin particle dispersion” of toners 1 to 14.

In Table 1, “the amount (% by mass) of the styrene-acrylic resin” is the proportion of the mass of the styrene-acrylic resin to the total mass of the resins (styrene-acrylic resin, crystalline polyester resin, and amorphous polyester resin) contained in the toner. When, for example, the crystalline polyester resin or the amorphous polyester resin has a hybrid structure, the mass of the styrene-acrylic resin is the sum of the content of the styrene-acrylic resin in the toner base particles and the content of the styrene-acrylic resin bonded to the crystalline polyester resin unit or the amorphous polyester resin unit.

TABLE 1

| | Styrene- | | |
|---|---|---|---|
| | acrylic | Cooling | Timing of |
| Toner | resin | rate | feeding amorphous polyester |
| No. | (% by mass) | (° C./min) | resin particle dispersion |
| Toner 1 | 70 | 20 | Toner particle diameter: 5.8 μm |
| Toner 2 | 70 | 25 | Toner particle diameter: 5.8 μm |
| Toner 3 | 70 | 11 | Toner particle diameter: 5.8 μm |
| Toner 4 | 70 | 7 | Toner particle diameter: 5.8 μm |
| Toner 5 | 70 | 20 | Toner particle diameter: 4 μm |
| Toner 6 | 70 | 20 | Toner particle diameter: 5.8 μm + |
| | | | Circularity0.922 |
| Toner 7 | 70 | 20 | Toner particle diameter: 5.8 μm + |
| | | | Circularity0.933 |
| Toner 8 | 70 | 20 | Toner particle diameter: 5.8 μm + |
| | | | Circularity0.947 |
| Toner 9 | 55 | 20 | Toner particle diameter: 5.8 μm |
| Toner 10 | 35 | 20 | Toner particle diameter: 5.8 μm |
| Toner 11 | 95 | 20 | Toner particle diameter: 5.8 μm |
| Toner 12 | 70 | 20 | Feeding at the initial stage |
| Toner 13 | 70 | 20 | Toner particle diameter: 5.8 μm + |
| | | | Circularity0.960 |
| Toner 14 | 70 | 4 | Toner particle diameter: 5.8 μm + |
| | | | Circularity0.960 |

### [Production of Developer]

Ferrite cores (100 parts by mass) and cyclohexyl methacrylate/methyl methacrylate (copolymer ratio: 5/5) copolymer resin particles (5 parts by mass) were fed to a high-speed mixer having agitation blades and were stirred and mixed at 120° C. for 30 min to forma resin coat layer on the surface of the ferrite core by means of mechanical impact. A carrier having a volume-based median diameter of 40 μm was thereby prepared.

The volume-based median diameter of the carrier was measured with a laser diffraction particle size distribution analyzer equipped with a wet-type disperser “HELOS & RODOS” (manufactured by Sympatec GmbH). Toners 1 to 14 were each added to the carrier at a concentration of 7 parts by mass. The resulting mixtures were each mixed with a micro V-shaped mixer (Tsutsui Scientific Instruments Co., Ltd.) at a rotation rate of 45 rpm for 30 min. Developers 1 to 14 were thereby produced.

### [Evaluation]

### <Peak Height Ratio (ATR Ratio)>

The ratio (P2/P1) of the height (P2) of the maximum absorption peak in the range of 1190 to 1220 cm⁻¹ to the height (P1) of the maximum absorption peak in the range of 690 to 710 cm⁻¹ and the ratio (P3/P1) of the height (P3) of the maximum absorption peak in the range of 1230 to 1300 cm⁻¹ to the height (P1) of the maximum absorption peak in the range of 690 to 710 cm⁻¹ were determined as in the procedure described above from the ratio of peak intensities in an absorption spectrum measured with a Fourier transform infrared spectrometer (Nicolet 380, manufactured by Thermo Fisher Scientific K.K.) by attenuated total reflection (ATR).

### <Image Formation>

For evaluation of images, a commercially available color copier “bizhub PRO C6500 (manufactured by Konica Minolta, Inc.)” was remodeled to a modified copier A such that the fixing temperature, the amount of adhering toner, and the system speed can be appropriately changed. The toner and the developer prepared above were sequentially loaded to the developing device of the modified copier A and were evaluated through a fixing experiment by fixing a solid image having an amount of adhering toner of 5 g/m² on size A4 paper, NPI (base weight: 128 g/m², manufactured by Nippon Paper Industries Co., Ltd.), under an environment of an ordinary temperature and an ordinary humidity (temperature: 20° C., humidity: 50% RH). The fixing experiment was repeated by setting the temperature of the lower fixing roller to 100° C. and raising the temperature of the upper fixing belt by 5° C. from 110° C. to 220° C. at a fixing rate of 300 mm/sec.

### <Low-Temperature Fixability (Under Offset)>

The term “under offset” refers to an image defect of detachment of toner from a transfer material, such as recording paper, due to insufficient melting of the toner layer by the heat applied while the transfer material is passing through the fixing device.

The lower limit of fixing temperature of the upper fixing belt not causing under offset in an image formed by the above-described procedure was determined and was used as an index of the low-temperature fixability. The fixability increases with a reduction in the lower limit of fixing temperature. A toner having a lower limit lower than 160° C. was defined as being acceptable.

### <Heat Resistance>

The toner (0.5 g) produced in the above was put in a 10-mL glass bottle having an internal diameter of 21 mm. The bottle was capped and was shaken with a shaker “Tapdenser KYT-2000” (manufactured by Seishin Enterprise Co., Ltd.) at room temperature for 600 times. The cap was removed, and the bottle was left to stand under an environment of a temperature of 55° C. and a humidity of 35% RH for 2 hours. Subsequently, the toner was placed on a sieve of 48 mesh (opening: 350 μm) in such a manner that the aggregates of the toner were not disintegrated. The sieve was set to a “powder tester” (manufactured by Hosokawa Micron Corporation) and was fixed with a pressing bar and a knobnut. The vibration strength was adjusted to give a feeding width of 1 mm, and the sieve was vibrated for 10 sec. The proportion (% by mass) of the amount of the toner remaining on the sieve was then measured, and the proportion of aggregated toner was calculated by the following expression. This test was repeated by fixing the humidity to 35% RH and raising the test temperature by 0.1° C. until the proportion of aggregated toner reached higher than 50% by mass. The highest test temperature (marginal heat-resistant storage temperature) at which the proportion of aggregated toner was not higher than 50% by mass was used as an index of heat-resistant storage properties. In the present invention, a toner having a marginal heat-resistant storage temperature of 56° C. or more was defined as being acceptable.

Proportion of aggregated toner (% by mass)=mass (g) of the toner remaining on sieve/0.5 (g)×100.

### <Fluidity>

Each (15 g) of the toners produced as described above was put in the respective plastic containers (100-mL ointment plastic bottle: manufactured by As One Corporation). The bottle was capped and was shaken with a shaker “Tapdenser KYT-4000” (manufactured by Seishin Enterprise Co., Ltd.) at room temperature for 1800 times. Subsequently, the toner was placed on a sieve of 300 mesh (opening: 45 μm) in such a manner that the aggregates of the toner were not disintegrated. The sieve was set to the shaker again and was shaken at a vibration strength of level 10 for 2 min. When the mass of a toner passed through the sieve was 10.5 g or more, the toner was judged to have high fluidity and no practical problem.

TABLE 2

| | | | Low-tem- | | | |
|---|---|---|---|---|---|---|
| | | | perature | Heat | | |
| Toner | | | fixability | resistance | Fluidity | |
| No. | P3/P1 | P2/P1 | (° C.) | (° C.) | (g) | Note |
| Toner 1 | 0.24 | 0.06 | 145 | 59.5 | 13.5 | The present |
| | | | | | | invention |
| Toner 2 | 0.23 | 0.03 | 157 | 59.4 | 14.2 | The present |
| | | | | | | invention |
| Toner 3 | 0.21 | 0.09 | 145 | 57.2 | 11.2 | The present |
| | | | | | | invention |
| Toner 4 | 0.14 | 0.19 | 145 | 56.5 | 10.5 | The present |
| | | | | | | invention |
| Toner 5 | 0.03 | 0.06 | 156 | 59.4 | 13.2 | The present |
| | | | | | | invention |
| Toner 6 | 0.48 | 0.06 | 146 | 57.9 | 13.5 | The present |
| | | | | | | invention |
| Toner 7 | 0.95 | 0.06 | 146 | 57.5 | 13.3 | The present |
| | | | | | | invention |
| Toner 8 | 5.50 | 0.06 | 147 | 56.8 | 13.4 | The present |
| | | | | | | invention |
| Toner 9 | 0.30 | 0.07 | 145 | 56.4 | 12.2 | The present |
| | | | | | | invention |
| Toner 10 | 0.35 | 0.08 | 145 | 56.0 | 11.7 | The present |
| | | | | | | invention |
| Toner 11 | 0.15 | 0.04 | 159 | 59.1 | 13.9 | The present |
| | | | | | | invention |
| Toner 12 | 0.01 | 0.06 | 170 | 58.5 | 13.5 | Comparative |
| | | | | | | Example |
| Toner 13 | 7.60 | 0.06 | 146 | 53.4 | 13.2 | Comparative |
| | | | | | | Example |
| Toner 14 | 8.20 | 0.40 | 145 | 52.3 | 6.5 | Comparative |
| | | | | | | Example |

The results shown in Table 2 clearly demonstrate that toners 1 to 11 of the present invention are good in every properties of low-temperature fixability, heat resistance, and fluidity from the practical application perspective, whereas toners 12 to 14 of Comparative Examples each have a problem in any of the fluidity, image density, and low-temperature fixability and are therefore unsuitable for practical application.

The entire disclosure of Japanese Patent Application No. 2015-075871 filed on Apr. 2, 2015 including description, claims, drawings, and abstract are incorporated herein by reference in its entirety.

What is claimed is:

1. An electrostatic latent image-developing toner comprising:
a styrene-acrylic resin;
an amorphous polyester resin; and
a crystalline polyester resin,
wherein the electrostatic latent image-developing toner shows maximum absorption peaks at least in absorption wavenumber ranges of 690 to 710 cm⁻¹, 1190 to 1220 cm⁻¹, and 1230 to 1300 cm⁻¹ in an absorption spectrum measured by attenuated total reflection with a Fourier transform infrared spectrometer, and
the ratio (P3/P1) of the height (P3) of the maximum absorption peak in the range of 1230 to 1300 cm⁻¹ to the height (P1) of the maximum absorption peak in the range of 690 to 710 cm⁻¹ is 0.02 to 6.00.

2. The electrostatic latent image-developing toner according to claim 1, wherein the amount of the styrene-acrylic resin is in a range of 50% to 90% by mass based on the total amount of the resins contained in the electrostatic latent image-developing toner.

3. The electrostatic latent image-developing toner according to claim 1, wherein the ratio (P2/P1) of the height (P2) of the maximum absorption peak in the range of 1190 to 1220 cm⁻¹ to the height (P1) of the maximum absorption peak in the range of 690 to 710 cm⁻¹ is 0.20 or less.

4. The electrostatic latent image-developing toner according to any one of claim 1, wherein the ratio (P2/P1) of the height (P2) of the maximum absorption peak in the range of 1190 to 1220 cm⁻¹ to the height (P1) of the maximum absorption peak in the range of 690 to 710 cm⁻¹ is in a range of 0.02 to 0.20.

5. The electrostatic latent image-developing toner according to any one of claim 1, wherein the ratio (P2/P1) of the height (P2) of the maximum absorption peak in the range of 1190 to 1220 cm⁻¹ to the height (P1) of the maximum absorption peak in the range of 690 to 710 cm⁻¹ is in a range of 0.02 to 0.10.

6. The electrostatic latent image-developing toner according to any one of claim 1, wherein the ratio (P3/P1) of the height (P3) of the maximum absorption peak in the range of 1230 to 1300 cm⁻¹ to the height (P1) of the maximum absorption peak in the range of 690 to 710 cm⁻¹ is in a range of 0.05 to 1.00.

7. The electrostatic latent image-developing toner according to any one of claim 1, wherein the ratio (P3/P1) of the height (P3) of the maximum absorption peak in the range of 1230 to 1300 cm⁻¹ to the height (P1) of the maximum absorption peak in the range of 690 to 710 cm⁻¹ is in a range of 0.05 to 0.50.

8. A method of producing an electrostatic latent image-developing toner according to any one of claim 1, the method comprising:
aggregating and fusing at least styrene-acrylic resin particles, amorphous polyester resin particles, and crystalline polyester resin particles; and
cooling an aqueous dispersion of the resultant toner base particles at a cooling rate of 10° C. to 30° C./min.
